(19) United States
(12) Patent Application Publication
(10) Pub. No.: US 2026/0358364 A1
(43) Pub. Date: Nov. 12, 2026

(54) ACCELEROMETER

(71) Applicant: ARKWRIGHT TECHNOLOGIES PTY LTD, Coromandel Valley (AU)

(72) Inventors: John Arkwright, Hawthorndene (AU); Ian Underhill, Eagle Heights (AU)

(73) Assignee: ARKWRIGHT TECHNOLOGIES PTY LTD, Coromandel Valley (AU)

(21) Appl. No.: 19/514,990

(22) PCT Filed: Aug. 29, 2024
(86) PCT No.: PCT/AU2024/050925

§ 371 Date: Feb. 27, 2026

(30) Foreign Application Priority Data
Sep. 1, 2023 (AU) 2023902826

(51) Int. Cl. G01P 15/093; G01D 5/353

(52) U.S. Cl. CPC G01P 15/093; G01D 5/35316

(57) ABSTRACT

An optical sensing device for measuring acceleration is disclosed. The device includes a body, a mass operably connected to the body such that the mass can move relative the body, and a first optical fibre having a first sensing region. The first optical fibre substantially extends in a first direction and is supported on the body. The first optical fibre is operatively connected to the mass such that movement of the mass relative the body causes at least a portion of the first optical fibre to move in a second direction substantially transverse of the first direction and generate a first strain in the first sensing region of the first optical fibre. The first strain generated in the first sensing region causes a change in an optical property of the first sensing region that can be used to calculate the acceleration.

### FIELD OF The INVENTION

The present disclosure relates to fibre optic-based accelerometers.

### BACKGROUND OF THE INVENTION

The are many applications in which acceleration and vibration need to be measured. For example, monitoring the condition of an engine by analysing the acoustic signature that is generated as it is running, or for inertial navigation.

Acceleration and vibration measurement can be achieved in many different ways using microelectromechanical systems (MEMS) or piezoelectric accelerometers. However, there are instances in which traditional accelerometers do not perform well, such as environments in which there are high levels of electromagnetic noise, in potentially explosive environments, or in situations where the data acquisition equipment must be located far away from the item being monitored.

In these and other instances there is a need for a different solution. Fibre optic accelerometers can overcome the limitations mentioned above as they are not affected by Electromagnetic Interference (EMI), are inherently ‘intrinsically safe’, and very long lengths of fibre can be used to connect the data acquisition unit to the sensing element without any significant loss in signal. However, fibre optic accelerometers still have issues.

### SUMMARY

An embodiment provides an optical sensing device for measuring acceleration, comprising:
a body;
a mass operably connected to the body such that the mass can move relative the body; and
a first optical fibre having a first sensing region, the first optical fibre substantially extending in a first direction and being supported on the body; and
the first optical fibre operatively connected to the mass such that movement of the mass relative the body causes at least a portion of the first optical fibre to move and generate a first strain in the first sensing region of the first optical fibre,
wherein the first strain generated in the first sensing region causes a change in an optical property of the first sensing region that can be used to calculate the acceleration.

In an embodiment, the optical sensing device comprises a second optical fibre substantially extending in the first direction and being supported on the body, the second optical fibre serving to urge the first optical fibre into direct or indirect contact with the mass. The first and second optical fibres may form a double helical structure that causes the first sensing region to define a curve shape.

In an embodiment, the second optical fibre has a second sensing region, wherein movement of at least a portion of the second optical fibre in a third direction substantially transverse of the first direction generates a second strain in the second sensing region that causes a change in an optical property of the second sensing region. A differential change in optical properties of the first sensing region and the second sensing region may be used to calculate the acceleration. The optical sensing device may be arranged such that a difference in optical response between the first sensing region and the second sensing region is substantially independent of a change in an ambient temperature. The first optical fibre may be arranged such that the first sensing region is curved in a plane transverse to the first direction in the absence of movement of the mass relative to the body, so that the strain generated in the first sensing region in response to movement of the mass relative to the body is positive for movement of the mass in a first mass movement direction relative to the body, and the strain generated in the first sensing region in response to movement of the mass relative to the body is negative for movement of the mass in a second mass movement direction relative to the body, the second mass movement direction substantially opposite to the first mass movement direction. The second optical fibre may be arranged such that the second sensing region is curved in a plane transverse to the first direction in the absence of movement of the mass relative to the body, so that the strain generated in the second sensing region in response to movement of the mass relative to the body is positive for movement of the mass in the second mass movement direction relative to the body, and the strain generated in the second sensing region in response to movement of the mass relative to the body is negative for movement of the mass in the first mass movement direction relative to the body. The curve may include a helical or a sinusoidal structure. Both of the first sensing region and second sensing region may be curved to define a double helix structure or a double sinusoidal structure. The first sensing region and the second sensing region may have nominally the same radii of curvature with respective centres of curvature of the first and second sensing regions disposed on opposite sides of the first and second optical fibres. A curvature of the first sensing region and second sensing region may have different radii of curvature. A radius of curvature of one of the first sensing region or second sensing region may tend towards infinity. A curvature of the first sensing region may extend in a first direction and a curvature of the second sending region may extend in a second direction. The first direction and second direction may be different.

The curve may be provided as a bulge in an otherwise straight optical fibre. One of the first optical fibre and the second optical fibre may be nominally linear thereby having a respective largely straight sensing region. Another of the first optical fibre and the second optical fibre may be provided with the bulge in the respective sensing region. The first optical fibre and the second optical fibre each may have the bulge in the respective sensing region.

The mass may be provided with a connector that contacts at least one of the first sensing region and second sensing region. The connector may be positioned between the first optical fibre and the second optical fibre so as to contact both the first optical fibre and second optical fibre. The connector may be configured to touch one of the first sensing region and second sensing region. The body and mass may be unitary.

The body and the mass may be disposed in a common plane and the mass may move relative the body in either a Z direction or Y direction relative the plane. The mass may be connected to the body with a spring member. The mass may be connected to the body by the first optical fibre and the second optical fibre. The mass may be connected to the body by one or more auxiliary fibres. The mass may be connected to the body such that movement of the mass is restricted to one degree of freedom.

The first sensing region and/or the second sensing region may include a Bragg grating. The first sensing region and/or the second sensing region may be configured to generate a response based on Rayleigh backscatter, optical frequency domain reflectometry, or optical time domain reflectometer or other optical mechanism for detecting strain in an optical fibre.

The body may have an open region and the mass fits within the open region. The first optical fibre and/or the second optical fibre may be maintained at a preset tension.

An embodiment provides a method of forming the sensing device as set forth above, the method comprising:
tensioning at least one of the first optical fibre and second optical fibre before the first optical fibre and second optical fibre are bonded to or supported by the body such that at least one of the first optical fibre and second optical fibre are pretensioned.

An embodiment provides an accelerometer system comprising:
an embodiment of the optical sensing device as set forth above;
a light source optically coupled to at least one of the first optical fibre and the second optical fibre; and
a detector optically coupled to at least the first optical fibre for recording a change in optical property of at least one of the first sensing region upon change in strain of the first optical fibre and/or second optical fibre caused by movement of the mass.

The first and second optical fibres may be connected together such that the first sensing region and the second sensing region can be interrogated by connecting a light source and detector to one end of the connected fibres. The accelerometer system may comprise a plurality of optical sensing devices such that the system is configured to detect acceleration in two or more axes.

An embodiment provides use of the accelerometer system to detect movement of an object in more than one axis.

An embodiment provides a method of measuring acceleration of an object using the optical sensing device, the method comprising:
providing an embodiment of the optical sensing device as set forth above;
disposing the optical sensing device in communication with the object such that movement of the object causes movement of the mass; and
whilst the object is moving:
   directing light down the first optical fibre and the second optical fibre; and
   detecting a change in strain of the first optical fibre and/or second optical fibre caused by movement of the mass.

### BRIEF DESCRIPTION OF THE DRAWINGS

Embodiments will now be described, by way of example only, with reference to the accompanying non-limiting drawings, in which:

FIG. 1 is a perspective side view of an embodiment of an optical sensing device.

FIG. 2a is a schematic top side view of FIG. 1.

FIG. 2b is a close up of region A in FIG. 2a.

FIG. 3 is a perspective side view of an embodiment of a fibre optic arrangement.

FIG. 4 is a perspective side view of an embodiment of a fibre optic arrangement.

FIG. 5 is a perspective side view of an embodiment of a fibre optic arrangement.

FIG. 6 is a perspective side view of an embodiment of a fibre optic arrangement.

FIG. 7 is a side view of an embodiment of a fibre optic arrangement.

FIG. 8 is a side view of an embodiment of a fibre optic arrangement.

FIG. 9a is a top side view of another embodiment of an optical sensing device.

FIG. 9b is a close up of region B in FIG. 9a.

FIG. 9c shows a schematic cross-sectional side view along line C-C in FIG. 9a.

FIG. 10 shows a plan view of an embodiment of an assembly used in an optical sensing device.

FIG. 11 shows a plan view of an embodiment of an assembly used in an optical sensing device.

FIG. 12 shows a schematic embodiment of an accelerometer system.

### DETAILED DESCRIPTION

Embodiments relate to an optical sensing device for measuring acceleration and uses thereof.

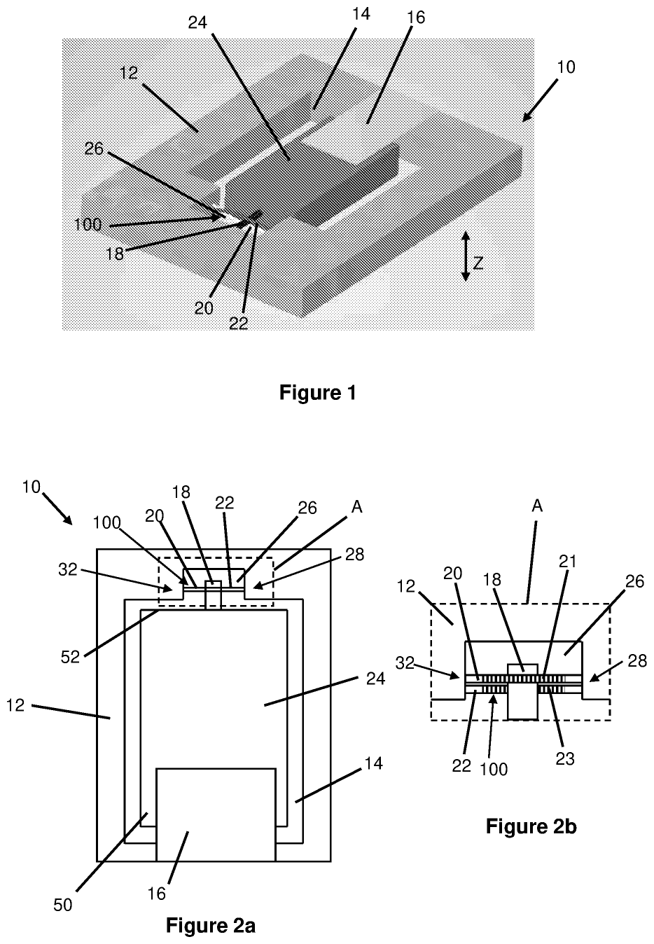

A first embodiment of a sensing device 10 for measuring acceleration is shown in FIG. 1. The device 10 has a body in the form of frame 12. The frame 12 has an open region in the form of cutout 14. Sitting within the cutout 14 is a mass in the form of proof mass 24. The cutout 14 also has head region 26 which can accommodate one or more optical fibres and associated connector, as is described below in more detail. The proof mass 24 is shown as sitting wholly within the cutout 14, but in some variations may extend or protrude from the cutout 14. The proof mass 24 is connected to the frame 12 such that the proof mass 24 can move relative to the frame 14. In the embodiment shown in FIG. 1, the proof mass 24 is connected to the frame 12 with a spring member such as a flexure spring 16 at a first end 50 of the proof mass 24 so that a second end 52 of the proof mass 24 can ‘swing’ or vibrate or move in a Z direction relative a plane of the frame 14. Put another way, the proof mass 24 may have a movement restricted to one degree of freedom. The flexure spring 16 may also be referred to as a torsion spring. In FIG. 2a and FIG. 2b, the Z direction extends into and out of the page. Although only one flexure spring 16 is shown, the sensing device 10 could have a plurality of flexure springs 16.

Movement of the frame 14, such as through a change of movement in an object to which the frame is secured to or through vibration, can cause the proof mass 24 to move or vibrate relative the frame 14. The amount that the proof mass 24 moves or vibrates is dependent on a direction and force of the movement and the flexure properties of the flexure spring 16. For example, a fast change in the Z direction will typically cause the proof mass 24 to move more than a slow change in the Z direction, whilst movement in an X or Y direction will typically cause little movement of the proof mass 24 given the flexure spring 16 restricts movement of the proof mass 24 in the X and Y direction. Similarly, increasing a stiffness of the flexure spring 16 changes the force required to move the proof mass 24.

The flexure properties of the flexure spring 16 are selected such that the sensing device 10 has a pre-set movement or vibration characteristic in which the sensing device 10 is optimised to sense. For example, the flexure spring 16 may be designed to resonate at a pre-defined frequency. A resonant frequency of the flexure spring 16 is dependent on a weight of the proof mass 24. In general, the resonant frequency, sensitivity, and resonant peak of the sensing device 10 can be modified based on the Spring-Mass-Damper model for accelerometers, that is:
Increasing a stiffness of the flexure spring 16 increases the resonant frequency and decreases sensitivity.
Increasing a mass of the proof mass 24 increases sensitivity and reduces resonant frequency.
Increasing the damping, for example by filling the internal volume of a sealed device with fluid, will reduce the amplitude of the resonant peak.

The sensing device 10 also has a first optical fibre 20 and a second optical fibre 22, as shown generally by fibre arrangement 100. As best seen in FIG. 2b, the fibre arrangement 100 has the first optical fibre 20 with a first sensing region 21 as represented by dashed lines and the second optical fibre 22 with a second sensing region 23 represented by dashed lines. The first optical fibre 20 and the second optical fibre 22 are supported on or by the frame 12 at a first side or region 32 and a second side or region 28 such that the first optical fibre 20 and the second optical fibre 22 are fixed to the frame 12.

The proof mass 24 has a connector in the form of rod 18 that is operably connected or engages with the first optical fibre 20 and/or the second optical fibre 22. The rod 18 may be referred to as a pin. In FIG. 2a, the first optical fibre 20 is shown as being “above” the rod 18 while the second optical fibre 22 is shown as being “below” the rod 18, but this order may be reversed. Movement of the proof mass 24 is transferred to at least one of the first optical fibre 20 and the second optical fibre 22 from the rod 18 such that an induced strain is applied to at least one of the first optical fibre 20 and the second optical fibre 22. This induced or applied strain causes at least one of a first optical property of the first sensing region 21 and a second optical property of the second sensing region 23 to change. This change in optical property is determined by a degree of movement of the proof mass 24. For example, a relatively large movement of the proof mass 24 tends to induce or apply a strain into one of the optical fibres 20 and 22 more than a relatively small movement. Accordingly, the change in optical properties of the first sensing region 21 and the second sensing region 23 can be used to determine the relative movement of the proof mass, and therefore an acceleration applied to the frame 12. Typically, a signal generated by a change in the optical properties of first sensing region 21 and/or second sensing region 23 is proportional to the load or force applied by the proof mass 24 through the rod 18. The first optical fibre 20 and the second optical fibre 22 may be in intimate contact or separated to facilitate the placement of the rod 18 or another member coupled to the proof mass 24.

In an embodiment, movement of the proof mass 24 causes a first strain to be generated in the first sensing region 21 and a second strain to be generated in the second sensing region 23. In an embodiment, movement of the proof mass 24 causes a first strain to be generated in the first sensing region 21 or a second strain to be generated in the second sensing region 23. In either embodiment, a change in an optical property of the respective sensing region 21 and/or 23 can be used to calculate the acceleration. An advantage of generating a first strain in the first sensing region 21 and a second strain in the second sensing region 23 is that a differential change in optical properties of the first sensing region 21 and the second sensing region 23 can be used to calculate the acceleration. Measuring a differential change can help to eliminate or at least reduce any changes in optical properties due to changes in temperature during use of the optical sensor 10. Put another way, measuring a difference in optical response can help to ensure the detection is largely independent from a change in ambient temperature.

In an embodiment, the optical fibres 20 and 22 are pre-tensioned prior to being fixed or secured to the frame 12 at the first side or region 32 and the second side or region 28 such that the optical fibres 20 and 22 once fixed or secured are maintained at a preset tension. Having the optical fibres 20 and/or 22 be under tension may help to improve a sensitivity of the sensing device 10.

The sensing regions 21 and 23 are shown in FIG. 2b in exemplary form and may vary depending on the type of optical fibres, the method or mode of sensing the optical regions, and so on. However, generally the sensing regions 21 and 23 have a length extending along an axis of the optical fibres 20/22 that is less than a length of the optical fibres 20/22 extending between locations where the optical fibres 20/22 are connected to the frame 12.

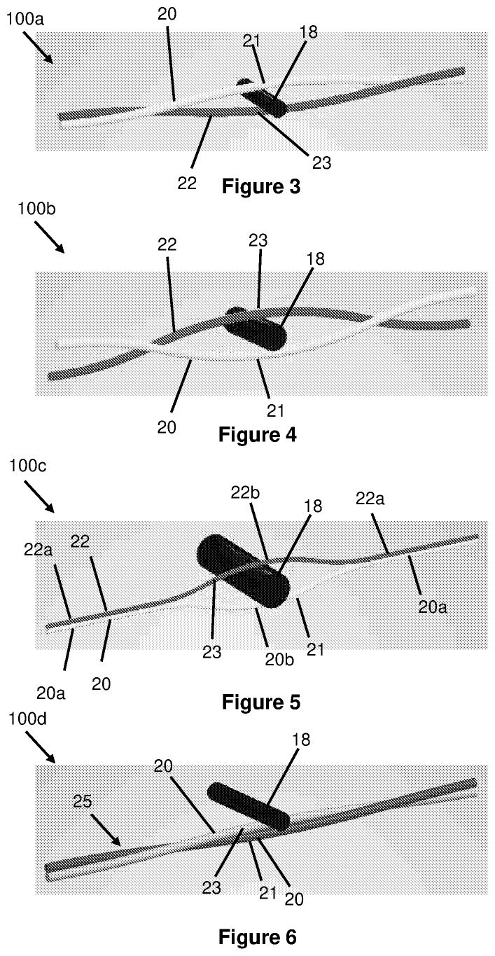

In FIG. 2a and FIG. 2b, the first optical fibre 20 and second optical fibre 22 are shown as being linear. However, as will now be explained in more detail with reference to FIG. 3 to FIG. 8, in an embodiment, at least one of the first optical fibre 20 and second optical fibre 22 ais curved or has a curved portion that defines at least a part of the respective sensing region 21/23. A curve or curved portion can help to increase a sensitivity of the sensing device 10.

In FIG. 3, the fibre arrangement 100a of the first optical fibre 20 and the second optical fibre 22 is such that the first optical fibre 20 and the second optical fibre 22 are wound around each other in a helix or helical structure. Therefore, the first optical fibre 20 and the second optical fibre 22 may form a double helix structure such that the first sensing region 21 and the second sensing region 23 each have a helix curve. Alternatively, the first optical fibre 20 or the second optical fibre 22 may be formed as having a helical structure such that the other of the first optical fibre 20 and second optical fibre 22 has a reduced curvature or is straight. In an embodiment, first optical fibre 20 or the second optical fibre 22 are bonded or fixed to the frame 12 or associated rigid structure at or near to the horizontal ‘nodes’ of the double helix or at or near to the cross over points of sinusoidally arranged fibres or at or near to the ends of the curved regions of the fibres depending on what arrangement is used to get the greatest differential response from the associated first sensing region 21 and second sensing region 23.

In the embodiment shown in FIG. 3, the rod 18 is positioned between the first optical fibre 20 and the second optical fibre 22 such that the rod 18 contacts both the first optical fibre 20 and the second optical fibre 22. It should be appreciated that in use movement of the rod 18 may temporarily break contact with one or both of the first optical fibre 20 and the second optical fibre 22. However, such breaking of contact may result in a fault condition. Accordingly, in an embodiment, the arrangement of the fibre optical fibre 20 and the second optical fibre 22 is such that during use they do not break contact with the rod 18. In an embodiment, and as best seen in FIG. 6, in fibre arrangement 100c, the rod 18 contacts one of the first optical fibre 20 and the second optical fibre 22, for example by touching a side of a bundle 25 formed from the first optical fibre 20 and the second optical fibre 22. Accordingly, the disclosure is not limited to the rod 18 being positioned between the first optical fibre 20 and the second optical fibre 22 and may instead positioned at or on a side of one of the first optical fibre 20 and the second optical fibre 22. Note that the curvature of the first optical fibre 20 and second optical fibre 22 in FIG. 8 is depicted in an exemplary manner and that the degree and type of curvature will vary from that depicted. The depiction of the curvature is merely to help describe and explain features of fibre arrangement 100c.

FIG. 4 shows another embodiment of a fibre arrangement 100b. Fibre arrangement 100b is similar to fibre arrangement 100a except that the first optical fibre 20 and the second optical fibre 22 have a sinusoidal curve rather than a helical curve. Therefore, the first optical fibre 20 and the second optical fibre 22 form a double sinusoidal structure where the first sensing region 21 and the second sensing region 23 each have a sinusoidal curve. The rod 18 is shown as being positioned between the sinusoidal curved first fibre optic 20 and sinusoidal curved second fibre optic 22. However, as shown in FIG. 6, in an embodiment the rod 18 can be positioned to a side of the fibre bundle 25 similar to fibre arrangement 100d.

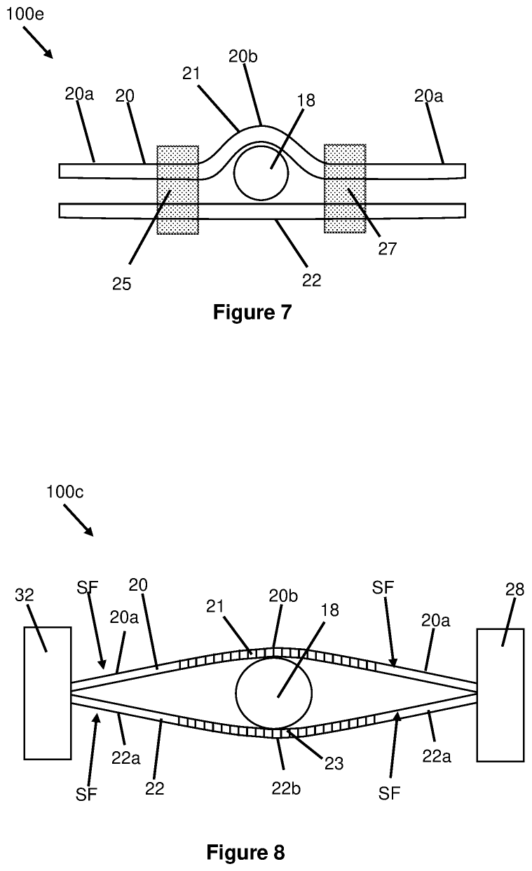

FIG. 5 shows another embodiment of a fibre arrangement 100c that utilises a bulge in each optical fibre. First optical fibre 20 have ends that are straight, as designated generally as straight regions 20a, where a bulge 20b is positioned between the straight regions 20a. Similarly, second optical fibre 22 has end that are straight, as designated generally as straight regions 22a, with a bulge 22b being positioned between the straight regions 22a. In an embodiment, the bulge in the fibres 20 and 22 is maintained by bonding the fibres 20 and 22 to a rigid frame such as 12 in FIG. 1 at or near the extremes of the bulged regions as shown in FIG. 7 with bonding regions 25 and 27.

The bulges 20b and 22b are positioned to approximately mirror one another such that the rod 18 can be received therebetween. However, bulges 20b and 22b have a bulge direction that extends away from one another. Therefore, when the rod 18 moves, a differential strain is passed into the fibres 20 and 22. The respective sensing regions 21 and 23 are located at the bulge 20b and 22b.

In an alternative embodiment, one of the first optical fibre 20 and the second optical fibre 22 has a reduced curvature or is linear thereby having a respective nominally straight sensing region, and another of the first optical fibre 20 and the second optical fibre 22 is provided with the bulge in the respective sensing region. For example, as shown in FIG. 7, fibre arrangement 100e has the first optical fibre 20 having the bulge 20b positioned between the straight regions 20a, with the second optical fibre 22 being nominally straight.

In an embodiment, having curves in the fibres 20/22 being approximately equal and opposite can make the temperature compensation for the sensor 10 easier to implement. However, any curvature may work as long as there is different curvature in each fibre i.e. different radii of curvature in each fibre or curved in opposite directions. In an embodiment, both fibres 20 and 22 remain in tension in the region where they contact with the pin 18. If tension in the fibre 20 and/or 22 goes to zero, and/or if the pin 18 breaks contact from the fibre 20 and/or 22 then the signal flatlines until the pin 18 contacts the fibre again. In use the fibres should remain in contact with the pin at all times.

The rod 18 is typically located at or proximal to the curve or bulge 20b/22b to ensure that any movement of the proof mass 24 and therefore the rod 18 is transferred to the sensing region 21/23, generates a strain and improves a sensitivity of the sensing device 10. By way of example only, FIG. 8 shows the relationship between the bulge 20b and first sensing region 21 of the first optical fibre 20, and the bulge 22b and second sensing region 23 of the second optical fibre 22. The first optical fibre 20 and the second optical fibre 22 are secured to the body at a first side or region 32 and a second side or region 28 of the frame 12. Typically, but not always, the first optical fibre 20 and the second optical fibre 22 will start to curve as soon as they leave regions 32 and 28, with the curvature being formed around rod 18. In an embodiment, he sensing regions 21 and 23 are positioned inboard from the side or regions 32 and 28 such that a sensing-free (SF) section of each optical fibre 20 and 22 boarders the respective sensing region 21 and 23. However, the sensing-free (SF) section is not required in all embodiments.

In an embodiment, the rod 18 creates the curvature in the fibres 20 and 22. The fibres are glued into the frame 12 first, and then the rod or pin 18 is pushed between the fibres to create, modify, or increase the curvature. The step of pushing the rod or pin 18 between the optical fibres 20 and 22 may also increase a strain in the optical fibres 20 and 22. Alternatively, the optical fibres 20 and 22 may be secured to the frame 12 in an un-tensioned state, and the step of pushing the rod or pin 18 between the optical fibres 20 and 22 induces a predefined strain in the fibres 20 and 22.

An advantage of having at least one optical fibre having a curve portion is that it can help to increase a sensitivity of the respective sensing region. However, only having one optical fibre with the curved portion may be sufficient to provide adequate sensitivity for certain applications.

In an embodiment, the first sensing region 21 and/or the second sensing region 23 includes a Bragg grating. Accordingly, the change in optical property as a result in a change in strain in the first sensing region 21 and/or the second sensing region 23 may be detected by a change in one or more properties of light (e.g. wavelength refractive properties, and so on) interacting with the Bragg grating. When a Bragg grating is used as the first sensing region 21 and/or the second sensing region 23, associated light sources, filters and control systems are used to direct light into and to detect light coming from the first optical fibre 20 and second optical fibre 22.

As an alternative to Bragg gratings, in an embodiment, the first sensing region 21 and/or the second sensing region 23 is configured to generate a response based on Rayleigh backscatter, optical frequency domain reflectometry, optical time domain reflectometry or other suitable technique for monitoring strain in an optical fibre.

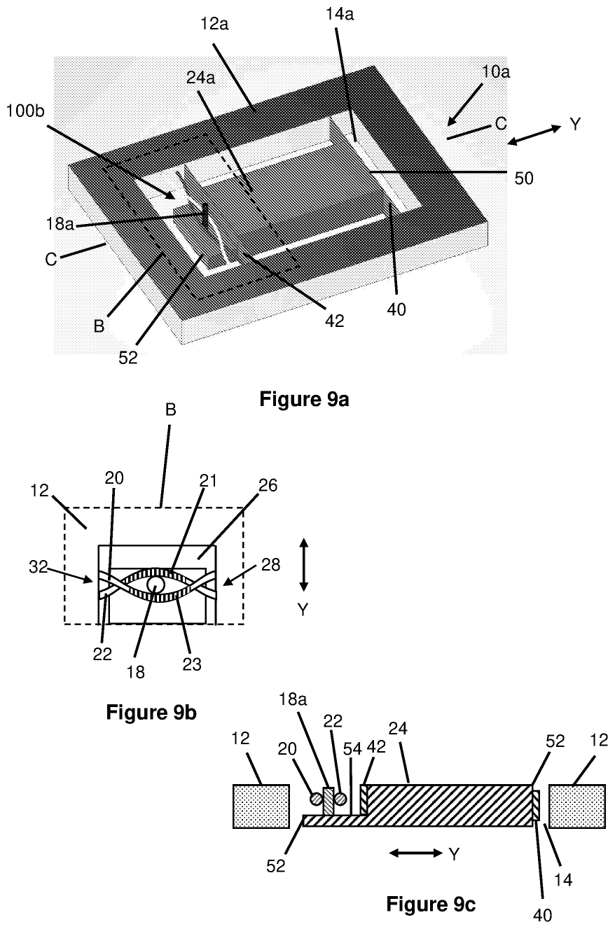

Another embodiment of a sensing device 10a will now be described with reference to FIG. 9a to FIG. 9c. Sensing device 10a is similar to sensing device 10 and like features are described with like references. In sensing device 10a the proof mass 24a can only move in the Y direction, in contrast to sensing device 10 where the proof mass 24 can only move in the Z direction.

In sensing device 10a, the proof mass 24a is connected to the frame 12a by one or more spring members. Specifically, the first end 50 of the proof mass 24a is connected to the frame with a first flexure spring 40, and a second flexure spring 42 near the second end 50 of the proof mass 24 connects the proof mass 24a to the frame 12a at a second location. The second flexure spring 42 is shown as being inboard from the second end 52, but in an embodiment the second flexure spring 42 is positioned at the second end 52 (not shown). As best seen in FIG. 9c, the proof mass 24a includes a shelf 54 that provides a space to accommodate the first optical fibre 20 and second optical fibre 22. A head portion 18a, which may form the rod 18 or to which the rod 18 can extend from, extends transversely away from the shelf 54 of the proof mass 24a and engages with first optical fibre 20 and second optical fibre 22. The shelf 54 is not required in all embodiments and the optical fibres 20 and 22 may be positioned above an upper or lower surface from the proof mass 24 and the rod 18a may extend from the same upper or lower surface (not shown).

The sensing device 10a is shown as having fibre arrangement 100b, but it could have any of fibre arrangement 100 to 100e.

The flexure springs 40 and 42 prevent the proof mass 24a from moving in X and Z directions such that it can only move in the Y direction. Therefore, only movement, such as vibration, of the proof mass 24a in the Y direction induces or generates strain in the first optical fibre 20 and/or second optical fibre 22.

In an embodiment, the proof mass 24a is connected to the frame 12 by the first optical fibre 20 and the second optical fibre 22 (not shown) or by a plurality of fibres such that only motion in the Y direction is allowed and motion in the X and Z directions are largely restricted.

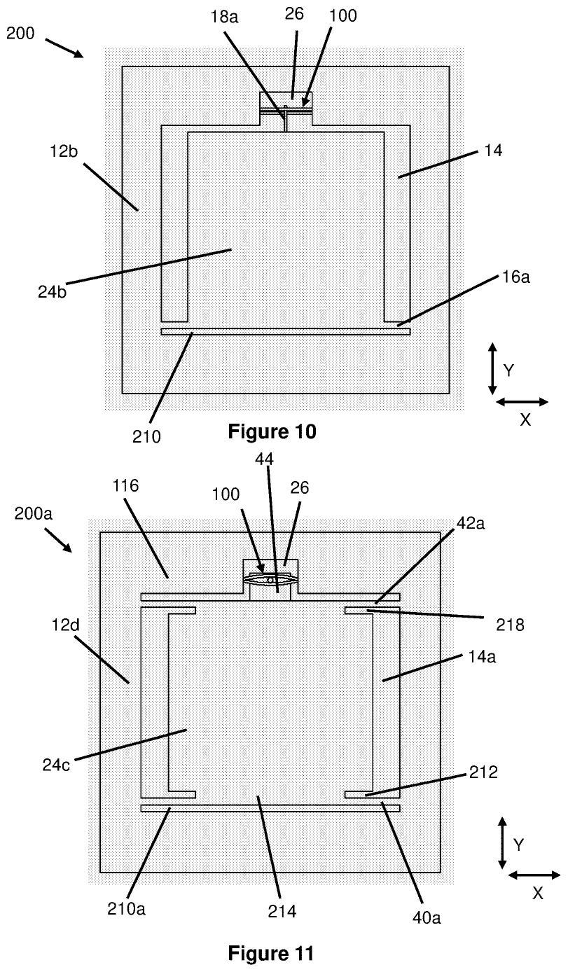

The proof mass 24/24a in device 10/10a is shown as being separate from the frame 12/12a and is connected thereto by flexure spring 16, 40 and/or 42. However, in an embodiment, the frame 12/12a, proof mass 24/24a, and flexure spring 16, 40 and/or 42 are unitary or integrally formed. Embodiments of a unitary structure will now be described with reference to FIG. 10 to FIG. 15.

In FIG. 10, unitary body 200 is formed from a single piece of material such as through laser cutting, 3D printing, or injection moulding. The frame 12b and proof mass 24b are formed by cutting cutout 14, head region 26, and bottom cutout 210. A portion of material is left intact between bottom cutout 210 and the cutout 14 which forms the torsion spring 16a thereby joining proof mass 24b to the frame 12b. The dimensions of the proof mass 24b can be adjusted by changing a dimension of the cutout 16a and bottom cutout 210. Similarly, a dimension of the torsion spring 16a can be adjusted by changing a relative spacing between the bottom cutout 210 and cutout 14. A resonance frequency of the torsion spring 16a and proof mass 24b vary depending on their design, sizes and mass. For example, a dimension of the torsion spring 16a can vary in the Y, X and Z direction. In an embodiment, an indent or cutout (not shown) can be provided to increase a length of the torsion spring 16a in the X direction.

The unitary body 200 utilises the design principle of sensing device 10 where the torsion spring 16 allows the proof mass 24 to move only in a Z direction. In FIG. 10, the Z direction is in and out of the page.

Another embodiment of a unitary body 200a is shown in FIG. 11. Unitary body 200a utilises the design principle of sensing device 10a where the flexure springs 40a and 42a allows the proof mass 24b to move only in a Y direction.

The frame 12d and proof mass 24c are formed by cutting cutout 14, head region 26, and a bottom cutout 210a that defines a bottom region or perimeter of the proof mass 24c. A portion of material is left intact between bottom cutout 210a and the cutout 14a which forms the first flexure spring 40a. In an embodiment, a joining portion 214 is formed between the flexure spring 40a and the proof mass 24d. In an embodiment, an indent 212 formed with cutout 14a and that extends inwards in the X direction in from a perimeter of the proof mass 24c is provided. The indent help to increase a length of the flexure spring 40a in the X direction. The dimensions of the proof mass 24d can be adjusted by changing a dimension of the cutout 40a, bottom cutout 210a and joining portion 214. Similarly, a dimension of the flexure spring 40a can be adjusted by changing a relative spacing between the bottom cutout 210a and cutout 14a, and a length of the indent 212a. The unitary body 200a also has the second flexure spring 42a formed by leaving intact a portion of material between cutout 14a and top cutout 216. A second intend 218 formed with the cutout 14a extends inwards along the X direction from an outside of the proof mass 24 also helps to define a portion of the second flexure spring 42a. The top cutout 216 includes the head region 26. Extending from the proof mass 24d is a tab 44. In an embodiment, the second flexure spring 42a extends from the tab 44. The rod 18a is provided on tab 44. A resonance frequency of the flexure spring 40a and 42a and proof mass 24c vary depending on their design, size(s) and mass. For example, a dimension of the flexure springs 40a and/or 42a can vary in the Y, X and Z direction.

In an embodiment, each unitary mass 200 and 200a has a dimension of approximately 25 mm by 25 mm.

The sensing device 10 can include or be formed from unitary body 200, and the sensing device 10a can include or be formed from unitary body 200a.

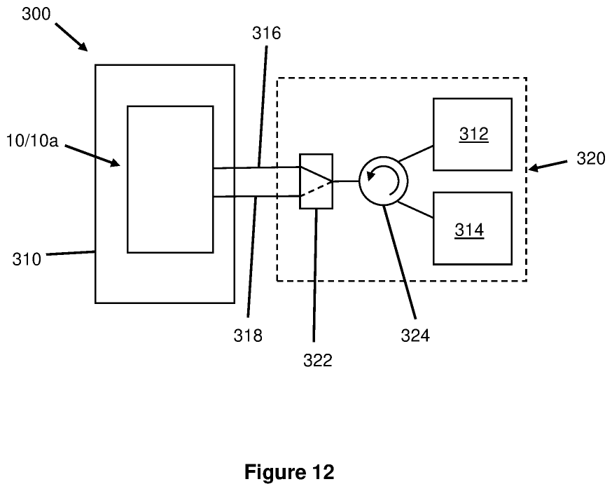

Also disclosed is an accelerometer system 300, as best shown in FIG. 12. Accelerometer system 300 is shown as including sensing device 10 or 10a. In use of accelerometer system 300, the sensing device 10 or 10a would be mounted to a structure 310 such that the frame is rigidly adhered or secured to the structure and the mass 24/24a/24b/24c is able to move in either the Z- or Y-axis to monitor acceleration. The accelerometer system 300 would typically include a light source 312, and a detector 314 that may be optically coupled to the first optical fibre 20 or to the first and second optical fibre 22. The detector 314 in use detects or records a change in an optical property of at least one of the first sensing region 21 and second sensing region 23 upon change in a strain of the first optical fibre 20 and/or second optical fibre 22 caused by movement of the proof mass 24/24a. The light source 312 and detector 314 may be formed as a unit 320.

The detector 314 is usually referred to as an FBG interrogator and includes a light source that directs broadband light to the FBG or FBGs and detects the light reflected by the gratings. The optical fibres containing the FBGs can either be spliced together, or an optical switch can be used to switch the light source and detector from one fibre to the next so that multiple FBGs and/or devices can be monitored simultaneously or sequentially.

In an embodiment of an accelerometer system, the unit 320 includes an optical switch 322 and optical circulator or splitter 324 situated between the light source 213 and optical detector 314 and the sensing device 10/10a so that light can be directed to multiple optical fibres or multiple accelerometers so that a plurality of devices or arrays of devices can be monitored sequentially. The unit 320 may also include a control system for controlling the light source 312 and the detector 314 and optical switch 322.

In the claims that follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments.

It is to be understood that, if any prior art publication is referred to herein, such reference does not constitute an admission that the publication forms a part of the common general knowledge in the art, in Australia or any other country.

Modifications and variations as would be apparent to a skilled addressee are deemed to be within the scope of the present disclosure.

1. An optical sensing device for measuring acceleration, comprising:
a body;
a mass operably connected to the body such that the mass can move relative the body; and
a first optical fibre having a first sensing region;
the first optical fibre substantially extending in a first direction and being supported on the body; and
the first optical fibre operatively connected to the mass such that movement of the mass relative the body causes at least a portion of the first optical fibre to move in a second direction substantially transverse of the first direction and generate a first strain in the first sensing region of the first optical fibre;
wherein the first strain generated in the first sensing region causes a change in an optical property of the first sensing region that can be used to calculate the acceleration.

2. An optical sensing device according to claim 1, comprising a second optical fibre substantially extending in the first direction and being supported on the body, the second optical fibre serving to urge the first optical fibre into direct or indirect contact with the mass.

3. An optical sensing device as claimed in claim 2, wherein the first and second optical fibres form a double helical structure that causes the first sensing region to define a curve shape.

4. An optical sensing device according to claim 2 or claim 3, wherein the second optical fibre has a second sensing region, and movement of at least a portion of the second optical fibre in a third direction substantially transverse of the first direction generates a second strain in the second sensing region that causes a change in an optical property of the second sensing region.

5. An optical sensing device according to claim 4, wherein a differential change in optical property of the first sensing region and the second sensing region is used to calculate the acceleration.

6. An optical sensing device according to any one of claims to 4, wherein the optical sensing device is arranged such that a difference in optical response between the first sensing region and the second sensing region is substantially independent of a change in an ambient temperature.

7. An optical sensing device according to any one of claims 1 to 6, wherein the first optical fibre is arranged such that the first sensing region is curved in a plane transverse to the first direction in the absence of movement of the mass relative to the body, so that the strain generated in the first sensing region in response to movement of the mass relative to the body is positive for movement of the mass in a first mass movement direction relative to the body, and the strain generated in the first sensing region in response to movement of the mass relative to the body is negative for movement of the mass in a second mass movement direction relative to the body, the second mass movement directions substantially opposite to the first mass movement direction.

8. An optical sensing device according claim 7, wherein the second optical fibre is arranged such that the second sensing region is curved in a plane transverse to the first direction in the absence of movement of the mass relative to the body, so that the strain generated in the second sensing region in response to movement of the mass relative to the body is positive for movement of the mass in the second mass movement direction relative to the body, and the strain generated in the second sensing region in response to movement of the mass relative to the body is negative for movement of the mass in the first mass movement direction relative to the body.

9. An optical sensing device according to claim 7 or claim 8, wherein the curve includes a helical or a sinusoidal structure.

10. An optical sensing device according to claim 8, wherein both of the first sensing region and second sensing region are curved to define a double helix structure or a double sinusoidal structure.

11. An optical sensing device according to claim 8, wherein the first sensing region and the second sensing region have nominally the same radii of curvature with respective centres of curvature of the first and second sensing regions disposed on opposite sides of the first and second optical fibres.

12. An optical sensing device according to claim 8, wherein the first sensing region and the second sensing region have different radii of curvature.

13. An optical sensing device according to claim 8, wherein a radius of curvature of one of the first sensing region and the second sensing region tends towards infinity.

14. An optical sensing device according to any one of claims 8 to 13, wherein a curvature of the first sensing region extends in a first direction and a curvature of the second sending region extends in a second direction, the first direction and second direction being different.

15. An optical sensing device according to claim 8, wherein the curve is provided as a bulge in an otherwise straight optical fibre.

16. An optical sensing device according to claim 15, wherein one of the first optical fibre and the second optical fibre is nominally linear thereby having a respective largely straight sensing region, and the other of the first optical fibre and the second optical fibre is provided with the bulge in the respective sensing region.

17. An optical sensing device according to claim 15, wherein the first optical fibre and the second optical fibre each has the bulge in the respective sensing region.

18. An optical sensing device according to any one of claims 1 to 17, wherein the mass is provided with a connector that contacts at least one of the first sensing region and second sensing region.

19. An optical sensing device according to claim 18, wherein the connector is positioned between the first optical fibre and the second optical fibre so as to contact both the first optical fibre and second optical fibre.

20. An optical sensing device according to claim 18, wherein the connector is configured to touch one of the first sensing region and second sensing region.

21. An optical sensing device according to any one of claims 1 to 20, wherein the body and mass are unitary.

22. An optical sensing device according to any one of claims 1 to 21, wherein the body and mass are disposed in a common plane and the mass can move relative the body in either a Z direction or Y direction relative the plane.

23. An optical sensing device according to any one of claims to 1 to 22, wherein the mass is connected to the body with a spring member.

24. An optical sensing device according to any one of claims 1 to 23, wherein the mass is connected to the body by the first optical fibre and the second optical fibre.

25. An optical sensing device according to any one of claims 1 to 24, wherein the mass is connected to the body by one or more auxiliary fibres.

26. An optical sensing device according to any one of claims 23 or 25, wherein the mass is connected to the body such that movement of the mass is restricted to one degree of freedom.

27. An optical sensing device according to any one of claims 1 to 26, wherein the first sensing region and/or the second sensing region includes a Bragg grating.

28. An optical sensing device according to any one of claims 1 to 27, wherein the first sensing region and/or the second sensing region is configured to generate a response based on Rayleigh backscatter, optical frequency domain reflectometry, or optical time domain reflectometer or other optical mechanism for detecting strain in an optical fibre.

29. An optical sensing device according to any one of claims to 1 to 28, wherein the body has an open region and the mass fits within the open region.

30. An optical sensing device according to any one of claims 1 to 29, wherein the first optical fibre and/or the second optical fibre is maintained at a preset tension.

31. An accelerometer system comprising:
the optical sensing device of any one of claims 1 to 30;
a light source optically coupled to at least one of the first optical fibre and the second optical fibre; and
a detector optically coupled to at least the first optical fibre for recording a change in optical property of at least one of the first sensing region upon change in strain of the first optical fibre and/or second optical fibre caused by movement of the mass.

32. An accelerometer system of claim 31, wherein the first and second optical fibres are connected together such that the first sensing region and the second sensing region can be interrogated by connecting a light source and detector to one end of the connected fibres.

33. An accelerometer system of claim 31 or 32, comprising a plurality of optical sensing devices such that the system is configured to detect acceleration in two or more axes.

34. Use of the system of any one of claims 31 to 33 to detect movement of an object in more than one axis.

35. A method of measuring acceleration of an object using the optical sensing device, the method comprising:
providing the optical sensing device of any one of claims 1 to 30;
disposing the optical sensing device in communication with the object such that movement of the object causes movement of the mass; and
whilst the object is moving:
directing light down the first optical fibre and the second optical fibre; and
detecting a change in strain of the first optical fibre and/or second optical fibre caused by movement of the mass.
